(19) United States
(12) Patent Application Publication
(10) Pub. No.: US 2016/0092895 A1
(43) Pub. Date: Mar. 31, 2016

(54) METHOD AND SYSTEM FOR IDENTIFYING MERCHANT MARKET SHARES BASED ON PURCHASE DATA

(71) Applicant: MasterCard International Incorporated, Purchase, NY (US)

(72) Inventor: Susan E. GROSSMAN, Ridgewood, NJ (US)

(73) Assignee: MASTERCARD INTERNATIONAL INCORPORATED, Purchase, NY (US)

(21) Appl. No.: 14/498,194

(22) Filed: Sep. 26, 2014

(51) Int. Cl. G06Q 30/02

(52) U.S. Cl. CPC G06Q 30/0204

(57) ABSTRACT

A method for identifying consumer segment market shares for a merchant includes: storing a plurality of consumer profiles, each profile including data related to a consumer including a measurement key and plurality of transaction data entries associated with a transaction involving the consumer, each including a merchant identifier for a merchant involved in the transaction; receiving a specific merchant identifier and consumer segments, each segment including a plurality of measurement keys each associated with a consumer; identifying, for each segment, consumer profiles in the database that include a measurement key corresponding to one of the associated keys; calculating, for each segment, a market share based on data included in transaction data entries in each associated consumer profile that includes the specific merchant identifier and transaction data entries in each associated consumer profile that does not include the specific merchant identifier; and transmitting the calculated market share for each segment.

### FIELD

The present disclosure relates to identification of market shares for one or more consumer segments of a market, specifically the analysis of transaction data for consumers to determine a merchant market share for a segment of consumers based on consumer spending in the segment for that merchant in comparison to other merchants.

### BACKGROUND

Merchants are often interested in gathering economic data. Merchants may wish to know statistics regarding their sales, advertising effectiveness, what consumers think about them, sales statistics of other nearby and/or competing merchants, and more. However, such data can often be difficult for a merchant to obtain. While a merchant may be able to keep track of their own sales, they are unable to track the spending of consumers who shop at other, possibly competing merchants, or to track what their customers are spending when they shop elsewhere.

Some entities, such as payment networks, may come across transaction data for consumer transactions with a plurality of merchants. However, in order to preserve consumer privacy and security, such data is often obtained without identification of the consumers or without obtaining additional data associated with the consumers. Thus, the payment network may be unable to identify consumers that may be part of a target market for a merchant or whose actions may otherwise be of interest to the merchant.

Thus, there is a need for improved technology to identify merchant market shares for a consumer segment based on transaction history for the consumers in the segment while maintaining privacy in the identification of the consumer segment.

### SUMMARY

The present disclosure provides a description of systems and methods for identifying consumer segment market shares for a merchant.

A method for identifying consumer segment market shares for a merchant includes: storing, in a profile database, a plurality of consumer profiles, wherein each consumer profile includes data related to a consumer including at least a measurement key and a plurality of transaction data entries, each transaction data entry including transaction data associated with a payment transaction involving the related consumer including at least a merchant identifier associated with a merchant involved in the associated payment transaction; receiving, by a receiving device, a specific merchant identifier and one or more consumer segments, wherein each consumer segment includes a plurality of measurement keys, each measurement key being associated with one consumer of a group of consumers having one or more common characteristics; identifying, for each consumer segment, a set of consumer profiles in the profile database that include a measurement key corresponding to one of the plurality of measurement keys included in the respective consumer segment; calculating, for each consumer segment, a market share for a merchant associated with the specific merchant identifier based on transaction data included in transaction data entries in each consumer profile in the associated set of consumer profiles that include the specific merchant identifier and transaction data included in transaction data entries in each consumer profile in the associated set of consumer profiles that do not include the specific merchant identifier; and transmitting, by a transmitting device, the calculated market share for each consumer segment.

A system for identifying consumer segment market shares for a merchant includes a profile database, a receiving device, a processing device, and a transmitting device. The profile database is configured to store a plurality of consumer profiles, wherein each consumer profile includes data related to a consumer including at least a measurement key and a plurality of transaction data entries, each transaction data entry including transaction data associated with a payment transaction involving the related consumer including at least a merchant identifier associated with a merchant involved in the associated payment transaction. The receiving device is configured to receive a specific merchant identifier and one or more consumer segments, wherein each consumer segment includes a plurality of measurement keys, each measurement key being associated with one consumer of a group of consumers having one or more common characteristics. The processing device is configured to: identify, for each consumer segment, a set of consumer profiles in the profile database that include a measurement key corresponding to one of the plurality of measurement keys included in the respective consumer segment; and calculate, for each consumer segment, a market share for a merchant associated with the specific merchant identifier based on transaction data included in transaction data entries in each consumer profile in the associated set of consumer profiles that include the specific merchant identifier and transaction data included in transaction data entries in each consumer profile in the associated set of consumer profiles that do not include the specific merchant identifier. The transmitting device is configured to transmit the calculated market share for each consumer segment.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying consumer segment market shares in accordance with exemplary embodiments.

FIG. 2 is a block diagram illustrating the processing server of FIG. 1 for the identification of consumer segment market shares in accordance with exemplary embodiments.

FIG. 3 is a flow diagram illustrating a process for identifying the market share for a merchant for a consumer segment using the system of FIG. 1 in accordance with exemplary embodiments.

FIG. 4 is a flow diagram illustrating a process for identifying consumer segment market shares using the processing server of FIG. 2 in accordance with exemplary embodiments.

FIG. 5 is a diagram illustrating identified market shares for consumer segments for a merchant in accordance with exemplary embodiments.

FIG. 6 is a flow chart illustrating an exemplary method for identifying consumer segment market shares for a merchant in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

### System for Identifying Consumer Segment Market Shares

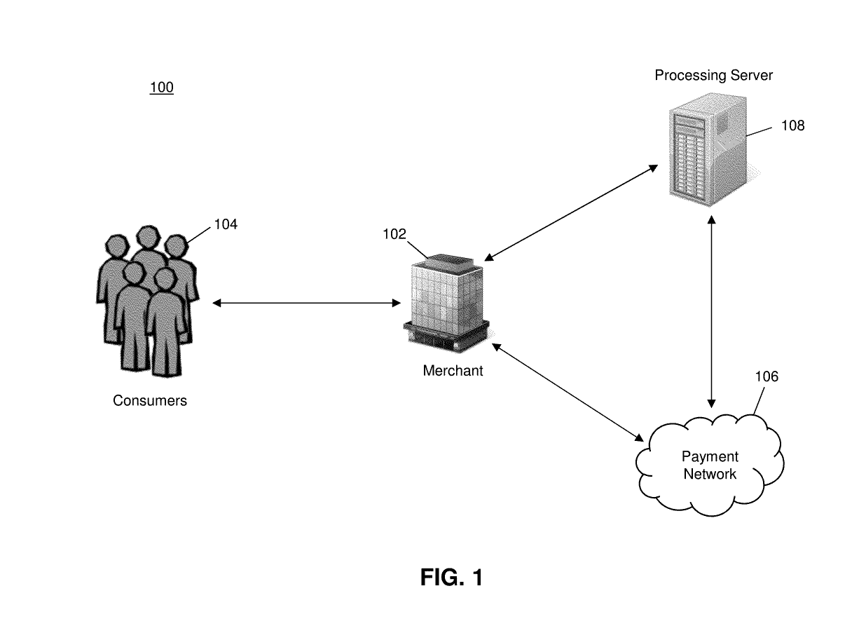

FIG. 1 illustrates a system 100 for identifying market shares for a merchant in a consumer segment using transaction data.

The system 100 may include a merchant 102. The merchant 102 may conduct a plurality of payment transactions with a group of consumers 104. The group of consumers 104 may include consumers that transact with the merchant 102, that transact with the merchant 102 and other merchants, or that transact with other merchants only and do not transact at the merchant 102. The consumers 104 in the group may transact with the merchant 102 using a plurality of payment methods.

Transactions conducted between the merchant 102 and consumers 104 may be processed by a payment network 106. The payment network 106 may process the payment transactions using methods and systems that will be apparent to persons having skill in the relevant art. As part of the processing, the payment network 106 may gather transaction data for the transactions being processed and may provide the transaction data to a processing server 108. The processing server 108, discussed in more detail below, may be configured to receive the transaction data and use it to identify market shares for the merchant 102.

As discussed in more detail below, the processing server 108 may calculate or otherwise identify market shares for the merchant 102 for the consumers 104. In some instances, the consumers 104 may be broken into a plurality of consumer segments. Consumer segments may be based on demographics, spend behaviors, loyalty programs, or any other type of criteria as will be apparent to persons having skill in the relevant art. The market shares may be based on transactions conducted by consumers 104 in the respective segment that involve the merchant 102 and transactions conducted by the consumers 104 in the segment that do not involve the merchant 102.

The consumer segments may be identified by the merchant 102 or a third party. For example, the merchant 102 may provide the processing server 108 with a plurality of measurement keys corresponding to a consumer segment. Measurement keys may be values that correspond to a consumer 104 but that are not personally identifiable to the corresponding consumer 104. For example, a measurement key may be one or more values associated with the corresponding consumer 104 that have been encrypted via a one-way method of encryption, hashed, or otherwise rendered unidentifiable to the corresponding consumer 104. For instance, a measurement key may be a hash of a plurality of demographic characteristics of the respective consumer 104. Additional information regarding the creation and use of measurement keys may be found in U.S. patent application Ser. No. 13/554,402, entitled “System and Method for Protecting Consumer Privacy in the Measuring of the Effectiveness of Advertisements,” filed on Jul. 20, 2012, by Curtis Villars et al., which is herein incorporated by reference in its entirety.

The processing server 108 may store the transaction data using measurement keys such that the transaction data cannot be associated with an identified consumer 104. The processing server 108 may receive the measurement keys from the merchant 102 that correspond to consumers 104 in a particular consumer segment. The processing server 108 may then identify the transaction data associated with the received measurement keys and may identify market share data for the merchant 102 for the consumer segment accordingly. In some embodiments, measurement keys may be received from a third party. For instance, a third party may maintain consumer data for the merchant 102 and may provide the consumer data to the processing server 108 in the form of the measurement keys. In another example, the merchant 102 may provide consumer data to a third party that may be configured to replace the consumer data with measurement keys to provide to the processing server 108 such that the processing server 108 does not obtain any personally identifiable data for the consumers 104.

Once the market share information has been identified by the processing server 108, the market share information may be provided to the merchant 102. By identifying market share information for a plurality of consumer segments based on transaction data, the processing server 108 may be able to provide valuable information to the merchant 102 regarding the spending of their consumers 104 with them, as well as with other merchants. In addition, by using a measurement key for the identification of transaction data for a consumer 104, the processing server 108 may be able to provide the market share data to merchants 102 without compromising consumer privacy or security. As a result, the methods and systems discussed herein may provide merchants with valuable market share data, while at the same time preserving consumer privacy and security.

### Processing Server

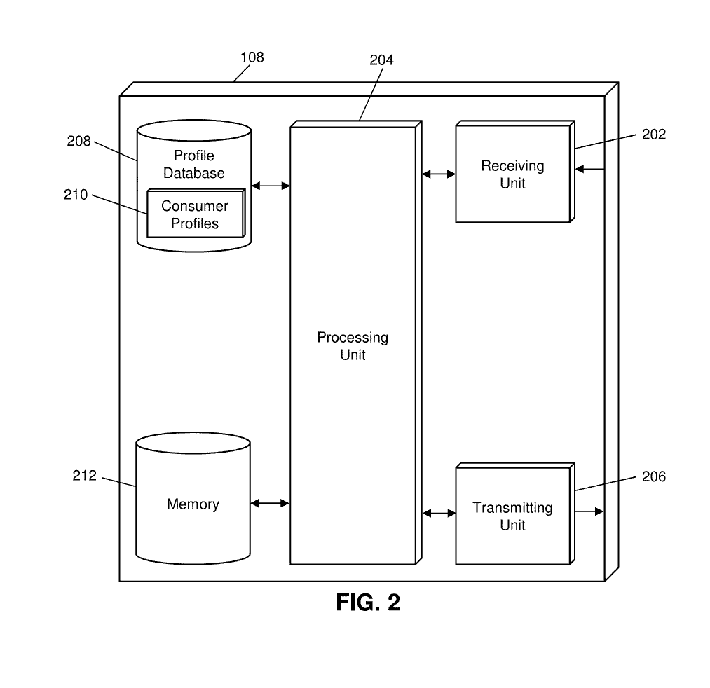

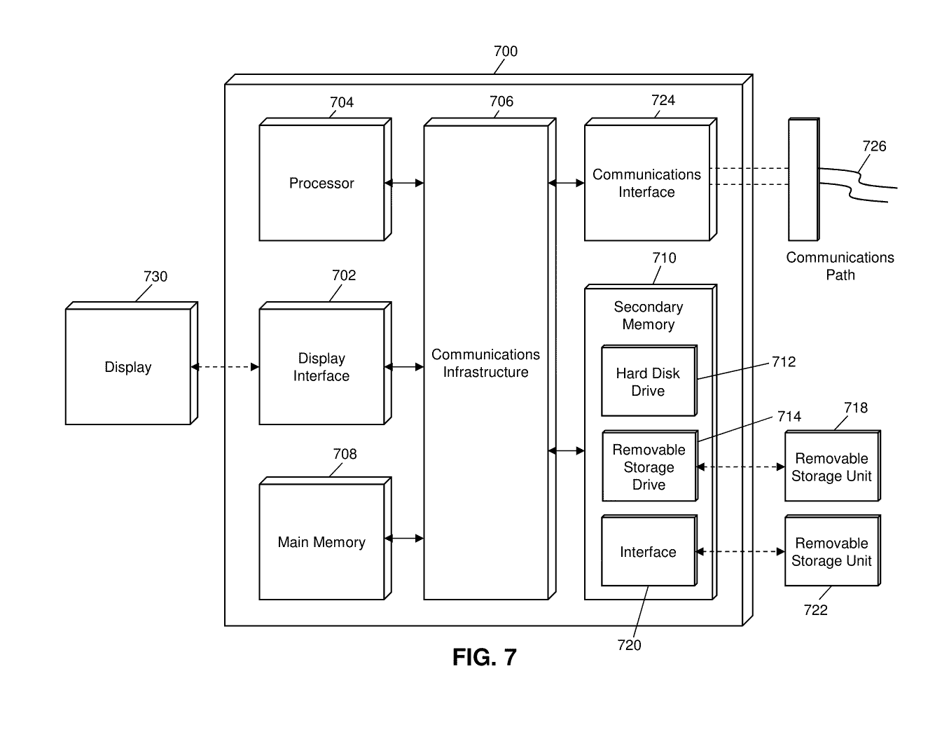

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive transaction data for a plurality of payment transactions involving the consumers 104, such as from the payment network 106, from merchants 102, etc. The receiving unit 202 may also receive a plurality of measurement keys, such as from the merchant 102 or an associated third party. In some instances, the receiving unit 202 may receive measurement keys for a plurality of consumer segments. Received measurement keys may be accompanied by a merchant identifier, such as associated with a merchant 102 for whom market share data is requested.

The processing server 108 may also include a processing unit 204. The processing unit 204 may be configured to perform the functions of the processing server 108 discussed herein as will be apparent to persons having skill in the relevant art. The processing unit 204 may store the received transaction data in a profile database 208. The profile database 208 may be configured to store a plurality of consumer profiles 210. Each consumer profile 210 may include data associated with a consumer 104.

Each consumer profile 210 may include at least a measurement key associated with the related consumer 104 and a plurality of transaction data entries that are related to payment transactions involving the related consumer 104. The transaction data entries may each be related to a payment transaction involving the related consumer 104 and may include at least a merchant identifier associated with a merchant involved in the payment transaction. The merchant identifier may be a unique value suitable for identification of the associated merchant, such as a merchant identification numbers, registration number, telephone number, street address, etc. In some instances, each transaction data entry may further include additional transaction data, such as a transaction amount, transaction time and/or date, geographic location, merchant data, product data, etc.

The processing unit 204 may be further configured to identify a plurality of consumer profiles 210 that correspond to a consumer segment based on measurement keys received by the receiving unit 202. For example, the processing unit 204 may identify consumer profiles 210 that include a measurement key that is included in a consumer segment comprising a plurality of measurement keys as received by the receiving unit 202.

The processing unit 204 may also be configured to identify a market share for a merchant 102 based on the transaction data entries included in the identified consumers profiles 210. The market share may be based on the transaction data included in transaction data entries whose merchant identifier corresponds to the merchant 102 for which the market share is being identified, compared to the transaction data included in transaction data entries whose merchant identifier does not correspond to the merchant 102. The transaction data that is used to identify the market share may be transaction amounts, transaction times and/or dates, geographic locations, or other suitable data that will be apparent to persons having skill in the relevant art. For instance, market share may be identified based on amount of total spending (e.g., using transaction amount), transaction frequency (e.g., number of transaction data entries), etc.

The processing server 108 may further include a transmitting unit 206. The transmitting unit 206 may be configured to transmit data over one or more networks via one or more network protocols. The transmitting unit 206 may be configured to transmit identified market share data to the merchant 102 or a third party in response to a request for market share data received by the receiving unit 202.

The processing server 108 may also include a memory 212. The memory 212 may be configured to store data suitable for performing the functions disclosed herein. For example, the memory 212 may be configured to store rules or algorithms used in the identification of market shares, geographic information, reporting tools, program code for execution of application programs configured to perform functions disclosed herein, etc. Additional data stored in the memory 212 will be apparent to persons having skill in the relevant art.

### Process for Identifying Market Share for a Merchant

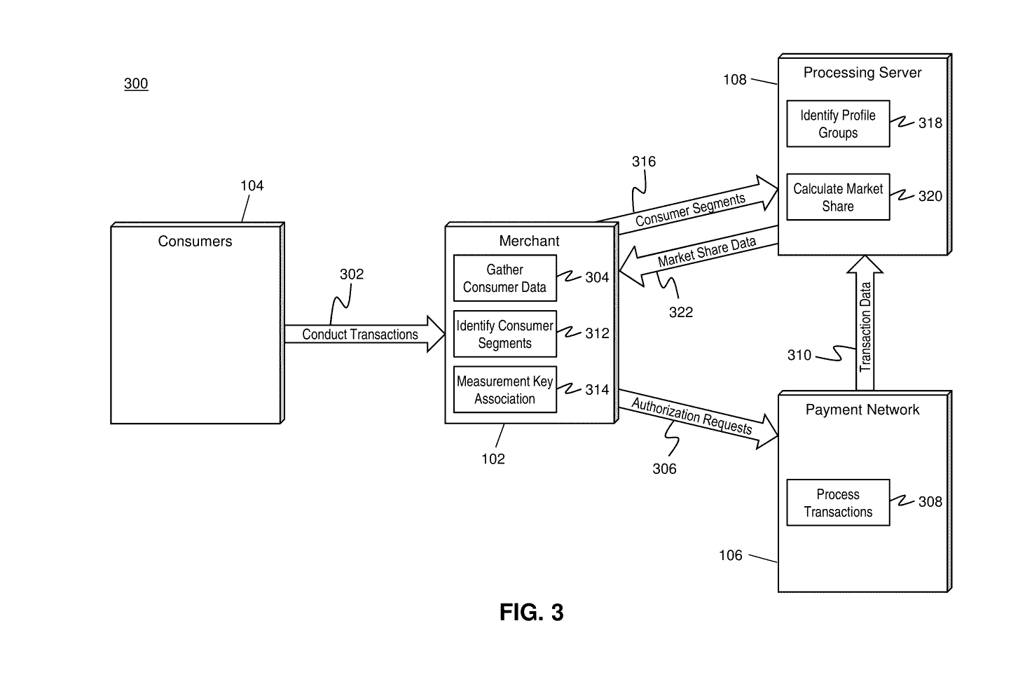

FIG. 3 illustrates a process 300 for the identification of market share for the merchant 102 of the system 100.

In step 302, the plurality of consumers 104 may engage in payment transactions with the merchant 102. In step 304, the merchant 102 may gather data associated with the transacting consumers 104, which may include payment data for use paying for the payment transactions. In some embodiments, the gathered data may also include additional consumer data, such as demographic data, loyalty program data, etc.

In step 306, the merchant 102 (e.g., or an acquiring bank or other financial institution acting on behalf of the merchant 102) may submit authorization requests for the payment transactions to the payment network 106. In step 308, the payment network 106 may process the payment transactions using methods and systems that will be apparent to persons having skill in the relevant art. In some embodiments, processing of the payment transactions may include transmitting authorization responses for each transaction back to the merchant 102, upon which the merchant 102 may act accordingly.

In step 310, the payment network 106 may transmit transaction data for the plurality of payment transactions to the processing server 108. The receiving unit 202 of the processing server 108 may receive the transaction data, which may be stored in the consumer profiles 210 of the profile database 208 by the processing unit 204. In step 312, the merchant 102 may identify one or more consumer segments for which market share data is requested. In step 314, the merchant 102 may identify measurement keys for each of the consumers 104 in each segment and may associate the respective measurement keys with the segments. In an exemplary embodiment, the merchant 102 may strip the consumer segments of any potentially personally identifiable information.

In step 316, the merchant 102 may transmit the measurement keys for each of the consumer segments to the processing server 108. The transmitted measurement keys may also be accompanied by a merchant identifier associated with the merchant 102. The receiving unit 202 may receive the measurement keys (e.g., and the merchant identifier), and, in step 318, the processing unit 204 may identify groups of consumer profiles 210 in the profile database 208. Each group may include consumer profiles 210 whose included measurement key corresponds to a measurement key included in that group as received from the merchant 102. In step 320, the processing unit 204 may calculate the market share for the merchant 102 for each consumer segment using the transaction data included in the consumer profiles 210 in the respective segment.

In some embodiments, the processing unit 204 may calculate a plurality of metrics for each consumer segment for the market share. For instance, the processing unit 204 may calculate a percentage of income share for the merchant 102, but may also calculate transaction frequency for the segment, overall spending, spending in the merchant industry, and additional metrics that will be apparent to persons having skill in the relevant art. In step 322, the transmitting unit 206 of the processing server 108 may transmit the calculated market shares and any other associated data to the merchant 102.

### Process for Identifying Consumer Segment Market Shares

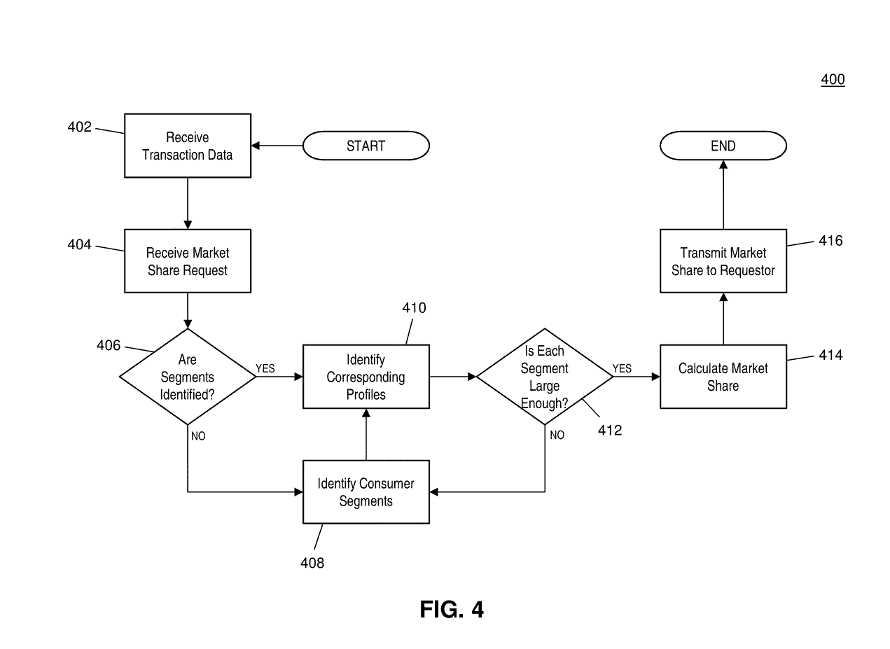

FIG. 4 illustrates a process 400 for identifying market shares for consumer segments for a merchant 102 by the processing server 108.

In step 402, the receiving unit 202 of the processing server 108 may receive transaction data for a plurality of payment transactions involving a plurality of consumers 104 and a plurality of merchants 102. The processing unit 204 of the processing server 108 may store the received transaction data as transaction data entries in a plurality of consumer profiles 210 in the profile database 208. Each consumer profile 210 may include transaction data entries for each payment transaction involving the related consumer 104.

In step 404, the receiving unit 202 may receive a market share request. The market share request may include at least a merchant identifier associated with a merchant 102 for whom market share is requested. In some instances, the market share request may also include a plurality of measurement keys for one or more consumer segments. In step 406, the processing unit 204 may check to see if the received market share request specifies the consumer segments.

If no segments are specified, then, in step 408, the processing unit 204 may identify consumer segments. Consumer segments may be identified based on demographic characteristics for all consumers 104 for whom data is stored or for consumers 104 that have transacted with the merchant 102, by a third party, or by other method as will be apparent to persons having skill in the relevant art. Identification of the consumer segments may include identification of the consumer profiles 210 included in each segment. If, in step 406, the processing unit 204 identifies that segments are specified in the market share request, then, in step 410, the processing unit 204 may identify corresponding consumer profiles 210 to be included in each segment based on the measurement keys included in the consumer profiles 210 and the respective consumer segments.

Once segments and corresponding consumer profiles 210 are identified, then, in step 412, the processing unit 204 may determine if the group of consumer profiles 210 for each segment is large enough. The determination may be based on the number of consumer profiles 210 in a segment and a predetermined value. The predetermined value may be such that at least that many consumer profiles 210 must be included in a segment in order to ensure consumer privacy and security. For example, the processing unit 204 may require that each consumer segment include at least ten consumer profiles 210. If not enough consumer profiles 210 are in a segment, then the process 400 may return to step 408, where the processing unit 204 may modify the segments, such as by combining two consumer segments.

Once the consumer profiles 210 for each segment have been identified and each segment is of suitable size, then, in step 414, the processing unit 204 may calculate the market share of the merchant 102 for each segment. Calculation of the market share may be based on the transaction data included in each transaction data entry in each consumer profile 210 in a segment that includes the merchant identifier associated with the merchant 102 (e.g., and received in the market share request) compared and the transaction data included in each transaction data entry in the consumer profile 210 that does not include the merchant identifier. In some embodiments, step 414 may also include the calculation of additional data associated with the market share and/or consumer segment. In step 416, the transmitting unit 206 of the processing server 108 may transmit the calculated market share and any other data in response to the received market share request.

### Identified Market Shares for Consumer Segments

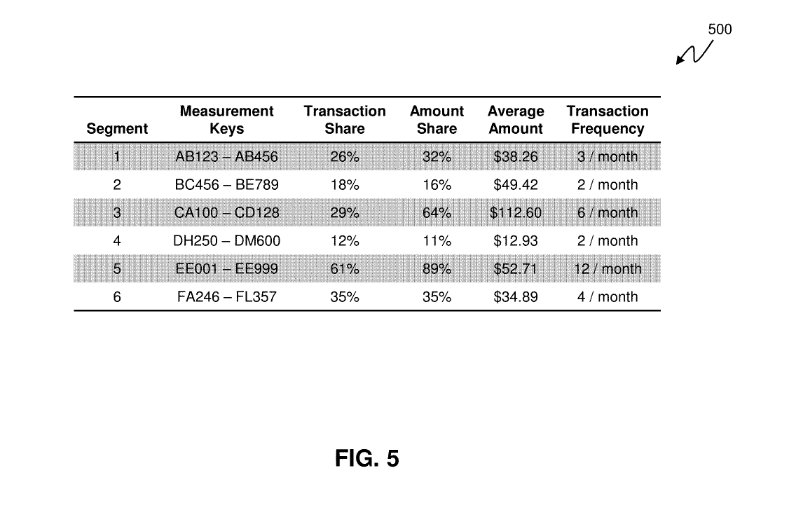

FIG. 5 illustrates identified market shares for a plurality of consumer segments for a merchant 102, such as by using the processes 300 and 400 illustrated in FIGS. 3 and 4, respectively.

FIG. 5 includes a table 500. The table 500 illustrates a plurality of consumer segments. Each consumer segment includes a plurality of measurement keys, illustrated as a range of alphanumeric keys. The table 500 also illustrates a transaction market share for a merchant 102 for each consumer segment, based on transaction data in consumer profiles 210 that include the measurement keys included in the respective range of measurement keys. The transaction market share may represent the percentage of transactions conducted by consumers 104 in the respective segment that are with the merchant 102 compared to other merchants. For example, transactions with the merchant 102 account for 26% of all transactions conducted by consumers in segment 1.

Table 500 also illustrates an amount share. The amount share may be the market share for the merchant 102 of the overall amount spent by consumers 104 in the respective segment. For example, in the example illustrated in FIG. 5, 89% of the overall spending by consumers 104 in segment 5 is at the merchant 102. In some embodiments, the transaction share and/or amount share may be with respect to other merchants in a particular industry, geographic area, or other categorization of merchants.

The table 500 may also include additional metrics calculated by the processing server 108 for each consumer segment. For instance, the table 500 illustrated in FIG. 5 illustrates an average transaction amount for payment transactions involving the consumers 104 in the respective consumer segment and a transaction frequency in terms of the number of payment transactions per month for the consumers 104 in the respective consumer segment. In some embodiments, the transaction amount and transaction frequency may be with respect to payment transactions involving the merchant 102. In other embodiments, the transaction amount and frequency may be for all transactions involving the consumers 104 in the segment, including transactions not involving the merchant 102. In some instances, the processing server 108 may calculate metrics for both embodiments.

### Exemplary Method for Identifying Consumer Segment Market Shares for a Merchant

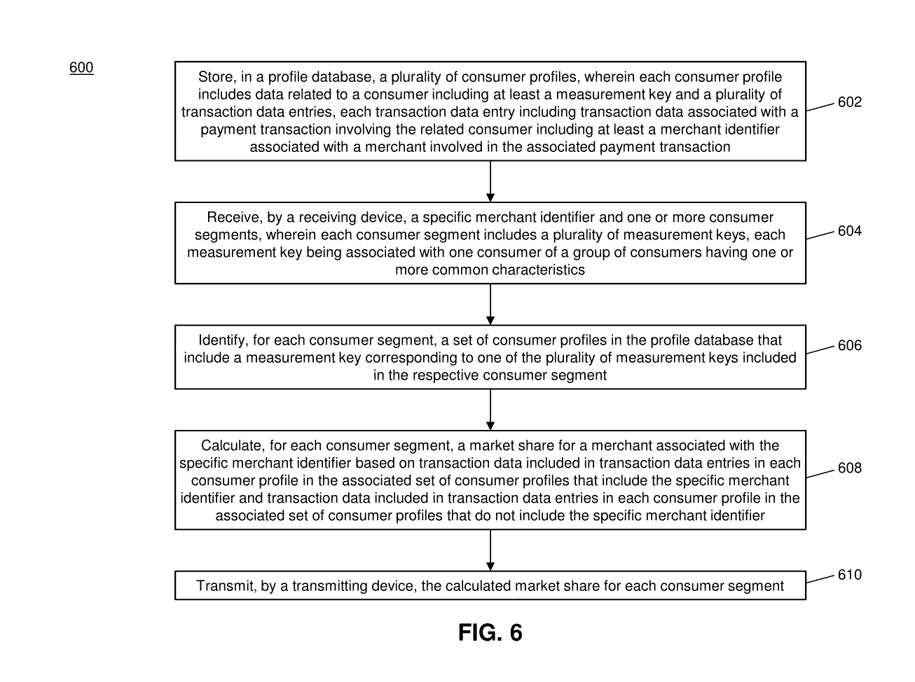

FIG. 6 illustrates a method 600 for identifying consumer segment market shares for a merchant based on transaction data for the consumer segment.

In step 602, a plurality of consumer profiles (e.g., consumer profiles 210) may be stored in a consumer database (e.g., the consumer database 208), wherein each consumer profile 210 includes data related to a consumer (e.g., consumer 104) including at least a measurement key and a plurality of transaction data entries, each transaction data entry including transaction data associated with a payment transaction involving the related consumer 104 including at least a merchant identifier associated with a merchant involved in the associated payment transaction. In one embodiment, the measurement key may not include any personally identifiable information.

In some embodiments, the measurement key may be produced by encrypting a plurality of consumer characteristics associated with the associated consumer 104 using a method of one-way encryption. In a further embodiment, the plurality of consumer characteristics may include at least one of: age, gender, income, residential status, familial status, marital status, occupation, education, zip code, and postal code. In one embodiment, the transaction data included in each transaction data entry may further include at least one of: transaction amount, transaction time and/or date, geographic location, point of sale data, product data, and redemption data.

In step 604, a specific merchant identifier and one or more consumer segments may be received by a receiving device (e.g., the receiving unit 202), wherein each consumer segment includes a plurality of measurement keys, each measurement key being associated with one consumer 104 of a group of consumers having one or more common characteristics. In some embodiments, the plurality of measurement keys may include at least a predetermined number. In a further embodiment, the predetermined number may be such that no consumers associated with a measurement key included in each respective consumer segment is personally identifiable.

In step 606, a set of consumer profiles 210 in the profile database 208 may be identified for each consumer segment that include a measurement key corresponding to one of the plurality of measurement keys included in the respective consumer segment.

In step 608, a market share may be calculated for each consumer segment for a merchant (e.g., the merchant 102) associated with the specific merchant identifier based on transaction data included in transaction data entries in each consumer profile 210 in the associated set of consumer profiles 210 that include the specific merchant identifier and transaction data included in transaction data entries in each consumer profile 210 in the associated set of consumer profiles 210 that do not include the specific merchant identifier. In some embodiments, the calculated market share may be based on a proportion of the transaction data entries that include the specific merchant identifier compared to the transaction data entries that do not include the specific merchant identifier.

In one embodiment, the transaction data included in each transaction data entry may further include a transaction amount, and the market share may be based on the transaction amount included in the transaction data entries that include the specific merchant identifier compared to the transaction amount included in the transaction data entries that do not include the specific merchant identifier. In another embodiment, the transaction data included in each transaction data entry may further include a transaction time and/or date, and the calculated market share may be based on a transaction frequency based on the transaction time and/or date included in each transaction data entry that includes the specific merchant identifier and the transaction time and/or date included in each transaction data entry that does not include the specific merchant identifier.

In step 610, the calculated market share for each consumer segment may be transmitted by a transmitting device (e.g., the transmitting unit 206).

### Computer System Architecture

FIG. 7 illustrates a computer system 700 in which embodiments of the present disclosure, or portions thereof, may be implemented as computer-readable code. For example, the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying consumer segment market shares for a merchant. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying consumer segment market shares for a merchant, comprising:
storing, in a profile database, a plurality of consumer profiles, wherein each consumer profile includes data related to a consumer including at least a measurement key and a plurality of transaction data entries, each transaction data entry including transaction data associated with a payment transaction involving the related consumer including at least a merchant identifier associated with a merchant involved in the associated payment transaction;
receiving, by a receiving device, a specific merchant identifier and one or more consumer segments, wherein each consumer segment includes a plurality of measurement keys, each measurement key being associated with one consumer of a group of consumers having one or more common characteristics;
identifying, for each consumer segment, a set of consumer profiles in the profile database that include a measurement key corresponding to one of the plurality of measurement keys included in the respective consumer segment;
calculating, for each consumer segment, a market share for a merchant associated with the specific merchant identifier based on transaction data included in transaction data entries in each consumer profile in the associated set of consumer profiles that include the specific merchant identifier and transaction data included in transaction data entries in each consumer profile in the associated set of consumer profiles that do not include the specific merchant identifier; and
transmitting, by a transmitting device, the calculated market share for each consumer segment.

2. The method of claim 1, wherein the measurement key does not include any personally identifiable information.

3. The method of claim 1, wherein the measurement key is produced by encrypting a plurality of consumer characteristics associated with the associated consumer using a method of one-way encryption.

4. The method of claim 3, wherein the plurality of consumer characteristics includes at least one of: age, gender, income, residential status, familial status, marital status, occupation, education, zip code, and postal code.

5. The method of claim 1, wherein the plurality of measurement keys included in each consumer segment is at least a predetermined number.

6. The method of claim 5, wherein the predetermined number is such that no consumer associated with a measurement key included in each respective consumer segment is personally identifiable.

7. The method of claim 1, wherein
the transaction data included in each transaction data entry further includes a transaction amount, and
the calculated market share is based on the transaction amount included in the transaction data entries that include the specific merchant identifier compared to the transaction amount included in the transaction data entries that do not include the specific merchant identifier.

8. The method of claim 1, wherein
the transaction data included in each transaction data entry further includes a transaction time and/or date, and
the calculated market share is based on a transaction frequency based on the transaction time and/or date included in each transaction data entry that includes the specific merchant identifier and the transaction time and/or date included in each transaction data entry that does not include the specific merchant identifier.

9. The method of claim 1, wherein
the calculated market share is based on a proportion of the transaction data entries that include the specific merchant identifier compared to the transaction data entries that do not include the specific merchant identifier.

10. The method of claim 1, wherein the transaction data included in each transaction data entry further includes at least one of: transaction amount, transaction time and/or date, geographic location, point of sale data, product data, and redemption data.

11. A system for identifying consumer segment market shares for a merchant, comprising:
a profile database configured to store a plurality of consumer profiles, wherein each consumer profile includes data related to a consumer including at least a measurement key and a plurality of transaction data entries, each transaction data entry including transaction data associated with a payment transaction involving the related consumer including at least a merchant identifier associated with a merchant involved in the associated payment transaction;
a receiving device configured to receive a specific merchant identifier and one or more consumer segments, wherein each consumer segment includes a plurality of measurement keys, each measurement key being associated with one consumer of a group of consumers having one or more common characteristics;
a processing device configured to
identify, for each consumer segment, a set of consumer profiles in the profile database that include a measurement key corresponding to one of the plurality of measurement keys included in the respective consumer segment, and
calculate, for each consumer segment, a market share for a merchant associated with the specific merchant identifier based on transaction data included in transaction data entries in each consumer profile in the associated set of consumer profiles that include the specific merchant identifier and transaction data included in transaction data entries in each consumer profile in the associated set of consumer profiles that do not include the specific merchant identifier; and
a transmitting device configured to transmit the calculated market share for each consumer segment.

12. The system of claim 11, wherein the measurement key does not include any personally identifiable information.

13. The system of claim 11, wherein the measurement key is produced by encrypting a plurality of consumer characteristics associated with the associated consumer using a method of one-way encryption.

14. The system of claim 13, wherein the plurality of consumer characteristics includes at least one of: age, gender, income, residential status, familial status, marital status, occupation, education, zip code, and postal code.

15. The system of claim 11, wherein the plurality of measurement keys included in each consumer segment is at least a predetermined number.

16. The system of claim 15, wherein the predetermined number is such that no consumer associated with a measurement key included in each respective consumer segment is personally identifiable.

17. The system of claim 11, wherein
the transaction data included in each transaction data entry further includes a transaction amount, and
the calculated market share is based on the transaction amount included in the transaction data entries that include the specific merchant identifier compared to the transaction amount included in the transaction data entries that do not include the specific merchant identifier.

18. The system of claim 11, wherein
the transaction data included in each transaction data entry further includes a transaction time and/or date, and
the calculated market share is based on a transaction frequency based on the transaction time and/or date included in each transaction data entry that includes the specific merchant identifier and the transaction time and/or date included in each transaction data entry that does not include the specific merchant identifier.

19. The system of claim 11, wherein
the calculated market share is based on a proportion of the transaction data entries that include the specific merchant identifier compared to the transaction data entries that do not include the specific merchant identifier.

20. The system of claim 11, wherein the transaction data included in each transaction data entry further includes at least one of: transaction amount, transaction time and/or date, geographic location, point of sale data, product data, and redemption data.
